(19) United States
(12) Patent Application Publication
(10) Pub. No.: US 2013/0086291 A1
(43) Pub. Date: Apr. 4, 2013

(54) SWITCHING LOGIC MODULE

(71) Applicants: Jörg Hagemann, Blomberg (DE); Peter Stövesand, Oelde (DE)

(72) Inventors: Jörg Hagemann, Blomberg (DE); Peter Stövesand, Oelde (DE)

(73) Assignee: PHOENIX CONTACT GMBH & CO. KG, Blomberg (DE)

(21) Appl. No.: 13/578,540

(22) PCT Filed: Feb. 10, 2011
(86) PCT No.: PCT/EP2011/052001

§ 371 Date: Dec. 17, 2012

(30) Foreign Application Priority Data
Feb. 12, 2010 (DE) 10 2010 007 953.7

(51) Int. Cl. G06F 13/40

(52) U.S. Cl. CPC G06F 13/4068
USPC 710/300

(57) ABSTRACT

The innovation applies to a switch logic module (1), which can be electrically and mechanically connected to and disconnected from I/O modules (2) that are arranged next to each other, whereby the I/O modules have an electrical contact and the mechanical connection can be established using the electrical contacts. According to the innovation, a multiplex logic is provided that can be used to connect the electrical contacts of the I/O modules cyclically for a predefined switch time to an output (8) of the switch module. This provides a space-saving and cost-effective solution that can be used to cyclically switch multiple electrical signals to one output with little installation effort and great flexibility.

### BACKGROUND

The innovation refers to a switch logic module with multiplex function, which is used in electrical controls, e.g. machine construction.

A variety of solutions are known for this application. However, there are often some very individual problems for which a solution is needed, and for which the existing products offer only very unsatisfactory solutions, whether they are too large, too small, don't offer the required amount of flexibility or the solutions are simply not economical.

This especially applies to the smallest of installations for which the use of conventional memory programming units (SPE) cannot be implemented economically and for which the available space is frequently insufficient. The currently known products used for this application indicate a uniform design for the major aspects, which makes the installation on the DIN rail of conventional electronics installation cabinets possible.

DE 10 2007 006 830 A1 defines a control and/or data transmission module, which serves to activate adjacent input/output modules (I/O modules) and which is plugged onto the modules to establish the mechanical and electrical connections. At least one signal channel is thereby connected to one data bus using a first connection and at least one additional connection connects a bus user to the signal channel.

The purpose of the innovation is to provide a space-saving and cost-efficient solution, which can be used to cyclically switch multiple electric signals to one output with little installation effort and great flexibility.

The solution for this task occurs according to the innovation due to the characteristics of Claim 1. Advantageous designs of the innovation are indicated in the subclaims.

Accordingly, a switch logic module is provided according to the innovation, which can be mechanically and electrically connected to and disconnected from the I/O modules that are arranged next to each other, whereby the I/O modules have at least one electrical contact and the mechanical connection can be established using the electrical contacts, which is marked by that a multiplex logic is provided, with which the electrical contacts of the I/O modules can be connected cyclically with an output of the switch module for a predefined switch time.

Typically, the I/O modules are thereby arranged parallel next to each other. Further, it should preferably be ensured that the switch logic module can be directly connected to the I/O modules.

In other words, it is suggested to plug a multiplex module onto the contacts that are arranged next to each other as an example. The output of the module is thereby preferably designed as an electrical contact, from where the multiplex device can be gripped.

Alternatively, or in addition to this, the output should preferably be designed as radio transmission receiver, which can be used to transmit the multiplex signal without any additional wiring using standard wireless solutions, such as Bluetooth, WLAN or DECT.

Furthermore, it thereby advantageous to design the switch times of the cycle of the multiplex logic configurable. This can be achieved especially space-saving using DIP switches.

It is furthermore suggested that the number of I/O modules to be connected by the switch logic module can be configured according to a preferred further development of the innovation, which will result in a broader range of applications. I/O modules that are spanned by the switch logic module but that are not required can thereby be replaced with cost-effective simple terminals with the same housing shape.

The number of connectable I/O modules is thereby preferably also adjustable using DIP switches. In contrast to programmable solutions, the DIP switch offers the advantage that it can be read out directly from the status. Furthermore, no electrical programming interface is required for the use of DIP switches for configuration.

Furthermore, the switch logic module is preferably designed so that the corresponding switch status can be signaled and thereby be made visible and/or fed to an analytic logic for interpretation of the output signal.

This preferably occurs in binary coding of the switch status digitally using a corresponding number of signal outputs and/or LEDs.

The switch logic module should preferably be supplied with power using the signal lines, e.g. multiplex output, so that no additional contact effort is required for power supply.

The innovation is explained in more detail below referencing the drawing based on preferred design variations.

Shown as follows

### BRIEF DESCRIPTION OF THE DRAWINGS

FIG. 1 shows a first design example of the switch logic module according to the innovation as a plug module for eight I/A modules that are mounted on a DIN rail next to each other.

FIG. 2 shows a principle switch diagram of the function of an application example for the switch logic module, and

FIG. 3 shows an application example of the switch logic module according to the innovation while monitoring multiple engine temperature sensors.

### DETAILED DESCRIPTION

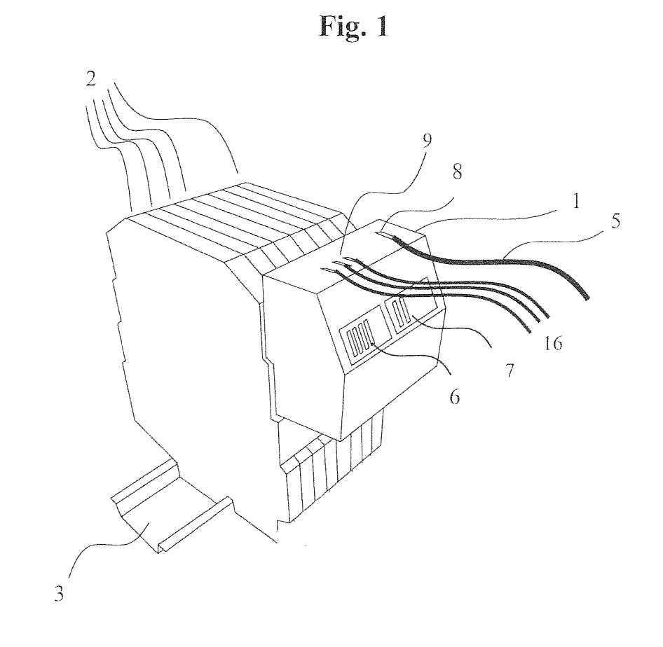

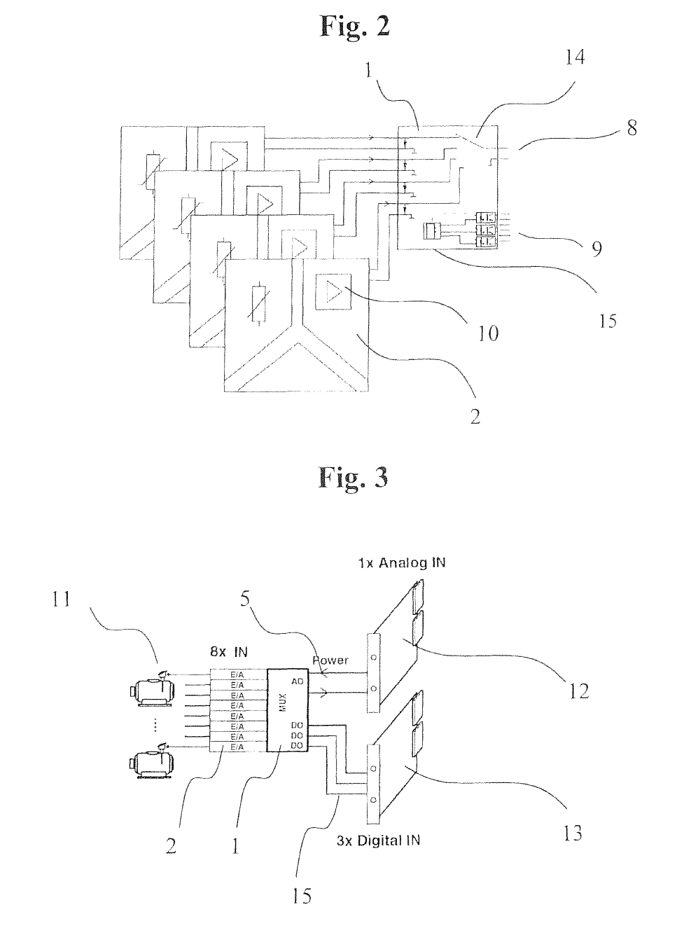

FIG. 1 shows eight I/O modules 2 that are arranged on a DIN rail 3 next to each other, which are spanned by a switch logic module 1. A signal is fed to each of the I/O modules and one output line 5 branches off the switch logic module 1. For example, within each I/O module 2, this signal can be amplified by the isolating amplifier 10 shown in FIG. 2, linked to other possible functions of the I/O module (e.g. timer, delay links or logic), or simply fed through it. The signal is sent to an electric contact, which is not shown here, e.g. an electrical terminal or an electrical bushing.

The housing of the switch logic module 1 is designed to complement the housing shapes of the I/O modules 2 so that it can be attached to them flush and thereby provides a natural mechanical secure fit. Fitting for electrical terminals or electrical bushings of the I/O modules 2, the switch logic module 1 has additional connectors that are not shown, which can be fitted and inserted in the terminals and/or bushings of the I/O modules 2 and not only warrant a mechanically secure fit but also an electrical connection.

FIG. 2 shows a principal switch diagram of the function of the switch logic module according to this defined preferred design of the innovation. This figure shows the multiplexer as a logical function of the switch logic module 1 and also the four I/O modules 2 that are shown here as an example. The signals of the I/O modules 2 will be routed to the switch contacts of the multiplexer. The multiplexer has a switch 14 that connects the inputs of the switch logic module cyclically with output 8 of the switch logic module. This switch is controlled with a switch logic 15, whereby the switch status of switch 14 is additionally signaled to the signaling outputs 16.

FIG. 3 shows an application example for the switch logic module 1 according to the innovation while monitoring multiple engine temperature sensors 11. The sensor signals from the engine temperature sensors 11 are routed to eight I/O modules 2, from which the sensor signals are routed through the switch logic module 1 through an analog output 8 of an evaluation unit 12.

Furthermore, the switch status of the eight possible switch settings of the switch logic module have binary encoding through three digital wires 16 and connected to a control and/or evaluation unit 13. The module is supplied with power through the analog signal output 8.

### REFERENCE LIST

Switch logic module 1
I/O module 2
DIN rail 3
Output wiring 5
DIP—switch switch time configuration 6
DIP—switch module number configuration 7
Output 8
Switch status output 9
Isolating amplifier 10
Engine temperature sensors 11
Evaluation unit 12
Control and/or evaluation unit 13
Switch 14
Switch logic 15
Signal wiring 16

What is claimed is:

1. Switch logic module, which can be mechanically and electrically connected to and disconnected from eight I/O modules, which are arranged next to each other, whereby the I/O modules have at least one electrical contact each and the mechanical connection can be established using the electrical contacts, which is characterized in that a multiplex logic is provided that can be used to cyclically connect the electrical contacts of the I/O modules for a predefined switch time to an output of the switch module.

2. Switch logic module according to claim 1, characterized in that the output of the switch logic modules has an electrical contact, preferably a terminal or a plug connector.

3. Switch logic module according to claim 1 marked in that the output of the switch logic module has a wireless device.

4. Switch logic module according to claim 1 characterized in that the multiplex logic is designed so that the switch time can be configured.

5. Switch logic module according to claim 4, characterized in that the switch time can be configured using a DIP switch.

6. Switch logic module according to claim 1 and characterized in that the number of I/O modules that can be connected to the switch logic module can be configured.

7. Switch logic module according to claim 6, characterized in that the configuration of the number of I/O modules that can be connected to the switch logic module can be configured with DIP switches.

8. Switch logic module according to claim 1 and characterized in that a signal device is provided that is used to signal the applicable switch status of the multiplex.

9. Switch logic module according to claim 8 and characterized in that the signal device has a preferably electrical switch status output that is used for a preferably binary signal to signal the switch status.

10. Switch logic module according to claim 8, characterized in that a digital signal of the switch status is provided.

11. Switch logic module according to claim 10, characterized in that the switch status can be signaled using electrical switch status outputs and/or LEDs.

12. Switch logic module according to claim 1, characterized in that the switch logic module power supply occurs using the output wiring or one of the signal wires.
